(19) United States
(12) Patent Application Publication
(10) Pub. No.: US 2017/0291200 A1
(43) Pub. Date: Oct. 12, 2017

(54) WATER WASHING METHOD AND SYSTEM FOR CRUDE OIL TANK

(71) Applicant: Seung Geun SON, Pyeongtaek-si, Gyeonggi-do (KR)

(72) Inventor: Seung Geun SON, Pyeongtaek-si, Gyeonggi-do (KR)

(21) Appl. No.: 15/512,843

(22) PCT Filed: Sep. 22, 2015
(86) PCT No.: PCT/KR2015/009976

§ 371 Date: Mar. 21, 2017

(30) Foreign Application Priority Data
Sep. 30, 2014 (KR) 10-2014-0131782

(51) Int. Cl. B08B 9/093; C10G 31/00; C10G 1/00

(52) U.S. Cl. CPC B08B 9/0933; B08B 9/0936; C10G 1/00; C10G 31/00

(57) ABSTRACT

A water washing method and system for a crude oil tank. The water washing method includes inputting washing water into the crude oil tank; injecting high-pressure water to the lower portions of the crude oil tank such that the sludge mixes with the washing water; and discharging mixture water in which the sludge is mixed with the washing water from the crude oil tank.

### TECHNICAL FIELD

The present invention generally relates to a water washing method and system for a crude oil tank, in which sludge that has been fixedly accumulated within a crude oil tank that temporarily stores crude oil before refining is removed from the crude oil tank with water.

### BACKGROUND ART

Crude oil pumped from the ground is temporarily stored in a crude oil tank before being shipped to a tanker or being loaded into refining facilities for refining. As crude oil is repeatedly input into and output from such a crude oil tank, sludge accumulates on and fixes to the bottom of the crude oil tank. An increase in the amount of the fixedly accumulating sludge reduces the storage capacity of the crude oil tank. At any point of time, a sludge removal operation must be carried out to remove the sludge from the crude oil tank.

Disclosed related-art patents relating to a crude oil tank washing apparatus for removing sludge fixedly accumulated in a crude oil tank include Korean Patent No. 10-1224010, titled “AUTOMATIC WASHING APPARATUS FOR CRUDE OIL TANK”, Korean Patent No. 10-0475172, titled “METHOD OF REMOVING SLUDGE FROM OIL TANK AND RECOVERING OIL THEREFROM”, and the like. The related art including Korean Patent No. 10-1224010 and Korean Patent No. 10-0475172 intended to wash a crude oil tank by inputting hot heat transfer oil into the crude oil tank such that fixed sludge is detached from the bottom of the crude oil tank and mixes with the heat transfer oil and subsequently discharging a mixture of the heat transfer oil and the sludge out of the crude oil tank using a pump. In addition, when part of the mixture that cannot be pumped remains on the bottom of the crude oil tank, workers wearing masks enter the crude oil tank and manually remove the remaining mixture. Since a material tends to easily dissolve into or mix with a material having a similar composition, the heat transfer oil is used for forming the heat transfer oil-sludge mixture in the related art.

While the speed of forming the heat transfer oil-sludge mixture is relatively fast at the early stage since the initially-input heat transfer oil is hot, the speed of forming the heat transfer oil-sludge mixture gradually decreases with the time as the temperature of the heat transfer oil is lowered. Discussing the natural process of forming the heat transfer oil-sludge mixture separately, there is no other factor to increase the speed of forming the heat transfer oil-sludge mixture except for stirring the heat transfer oil. Thus, it takes a long time to produce the heat transfer oil-sludge mixture. In the related art, the residue of the sludge remains on the bottom of the crude oil tank since the pump cannot discharge it. In this case, workers enter the crude oil tank and manually remove the residue of the sludge. Since the interior of the crude oil tank contains harmful components, safety is not guaranteed and accidents sometimes occur. In addition, in the related art, the sediment (mostly sludge) incinerated by the mixture of the heat transfer oil and the sludge discharged from the crude oil causes the problem of environmental pollution.

### DISCLOSURE

### Technical Problem

An object of the present invention is to provide a water washing method for a crude oil tank using water for washing the crude oil.

Further, another object of the present invention is to provide a water washing method for a crude oil tank using hot steam or high-pressure water for washing the crude oil.

Further, another object of the present invention is to provide a water washing method for a crude oil tank without accidents.

Further, another object of the present invention is to provide a water washing method for a crude oil tank reusing of waste oil and dirty water, minimizing environmental pollution.

### Technical Solution

An aspect of the present invention provide a water washing method for a crude oil tank including inputting washing water into the crude oil tank; injecting high-pressure water to the lower portions of the crude oil tank such that the sludge mixes with the washing water; and discharging mixture water in which the sludge is mixed with the washing water from the crude oil tank.

The water washing method may further include, when a concentration of the sludge in the discharged mixture water is smaller than a predetermined value, inputting swirling water to the lower portions of the crude oil tank from a central upper portion of the crude oil tank such that the mixture water centrifugally gathers near an inner wall of the crude oil tank.

The water washing method may further include spraying hot steam to the lower portions of the crude oil tank such that the sludge is substantially melted.

The water washing method may further include refining the mixture water to divide the mixture water into waste oil, dirty water, and solid wastes to be incinerated.

wherein a dirty water divided from the mixture water through refining is to be reused in water washing for the crude oil tank.

Another aspect of the present invention provides a water washing system for a crude oil tank including a water supply pump inputting washing water into the crude oil tank; a high-pressure pump injecting high-pressure water to the lower portions of the crude oil tank; and a drain pump discharging mixture water in which sludge is mixed with the washing water from the crude oil tank.

The water washing system may further include a rotary unit inputting swirling water to the lower portions of the crude oil tank from a central upper portion of the crude oil tank such that the mixture water gathers near an inner wall of the crude oil tank.

The water washing system may further include a boiler producing hot steam to be sprayed to the lower of the crude oil tank.

The water washing system may further include a refiner refining the mixture water discharged through the drain pump to divide the mixture water into waste oil, dirty water and solid wastes to be incinerated.

The water washing system may further include a recycling pump supplying the dirty water refined and divided from the mixture water by the refiner to a water tank.

### Advantageous Effects

According to the present invention, fixed sludge is more rapidly substantially melted using hot high-pressure steam, whereby the substantially-molten sludge is more rapidly detached from the bottom of the crude oil tank and easily mixes with washing water.

Further, workers can enter the crude oil tank without masks for the finishing operation. The mixture water discharged from the crude oil tank in the washing operation is refined and divided into waste oil, dirty water, and solid wastes to be incinerated.

Further, The waste oil and the dirty water are recycled, and only the solid wastes are incinerated, thereby minimizing the amount of discarded components. The recyclability of energy sources is excellent, and environmental pollution is reduced.

### DESCRIPTION OF DRAWINGS

FIG. 1 is a flowchart illustrating an embodiment of a water washing method for a crude oil tank according to the invention;

FIG. 2 is a schematic view illustrating the overall configuration of an embodiment of a water washing system for a crude oil tank according to the invention;

FIG. 3 is a diagram illustrating an operation of inputting inert gas into a crude oil tank;

FIG. 4 is a diagram illustrating an operation of inputting washing water into the crude oil tank;

FIG. 5 is a diagram illustrating an operation of spraying steam and injecting high-pressure water into the crude oil tank;

FIG. 6 is a diagram illustrating an operation of discharging mixture water from the crude oil tank;

FIG. 7 is a diagram illustrating an operation of inputting swirling water into the crude oil tank; and

FIG. 8 is a diagram illustrating an operation of refining the mixture water discharged and collected.

### BEST MODE

Reference will now be made in greater detail to exemplary embodiments of a water washing method and system for a crude oil tank according to the present invention in conjunction with the accompanying drawings. Wherever possible, the same reference numerals will be used throughout the drawings and the description to refer to the same or like parts. The present invention will now be described in detail based on aspects (or embodiments) thereof. The present invention may, however, be embodied in many different forms and should not be construed as being limited to only the embodiments set forth herein, but should be construed as covering modifications, equivalents or alternatives falling within ideas and technical scopes of the present invention.

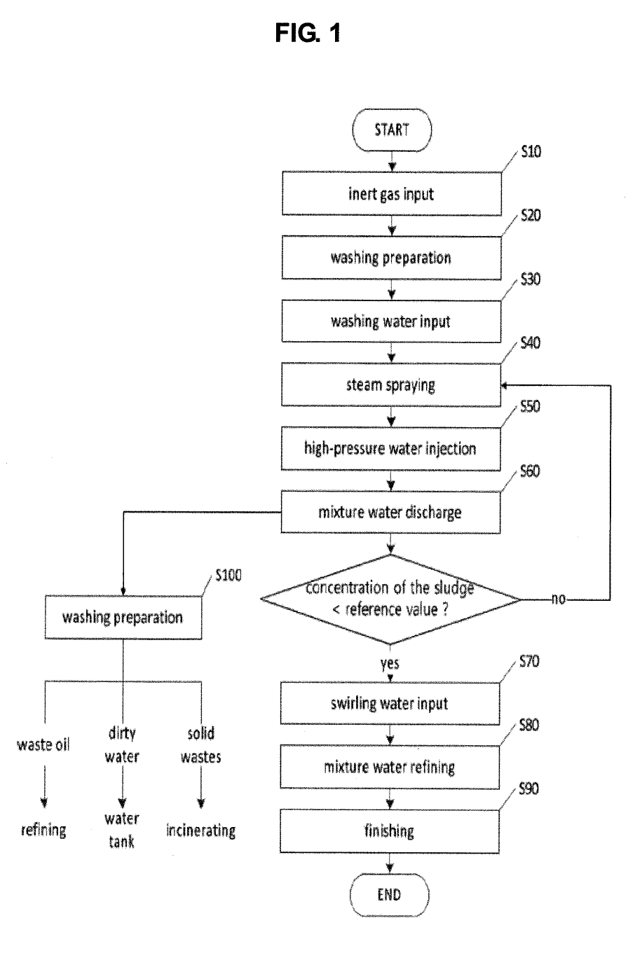

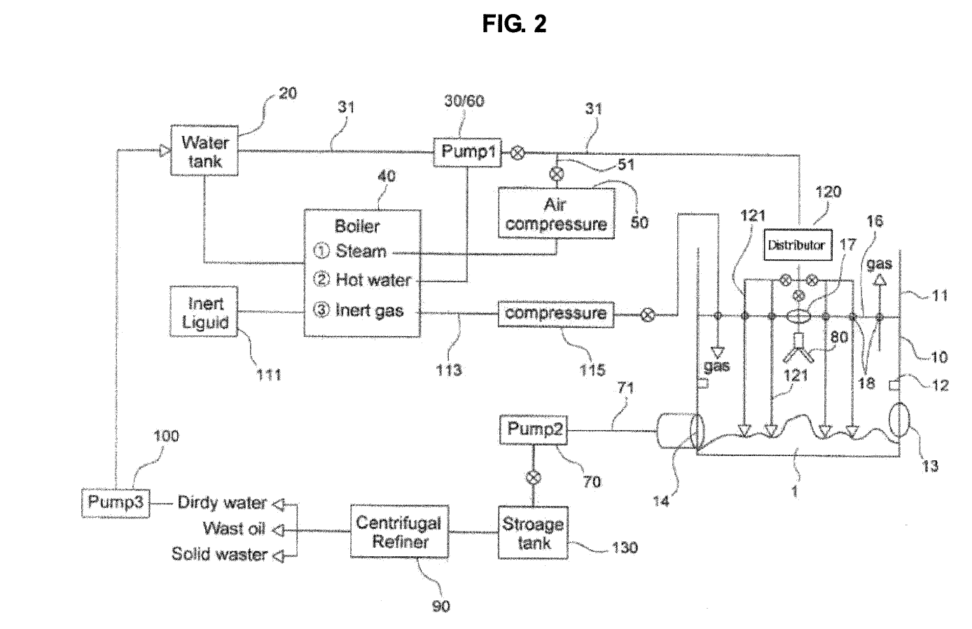

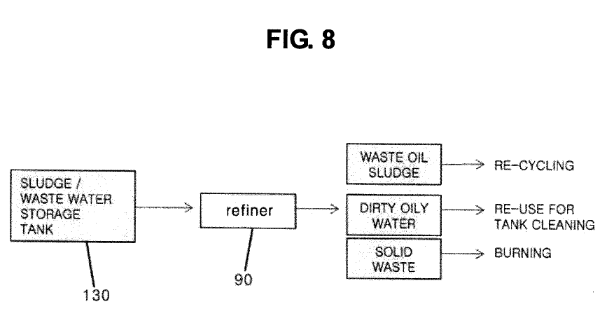

A water washing method for a crude oil tank according to the invention will be described in brief with reference to FIG. 1, and specific washing processes will be described along with a brief description of a water washing system for a crude oil tank according to the invention with reference to FIG. 8 from FIG. 2.

First, a crude oil tank 10 includes a body 11 having a large cylindrical structure, the diameter of which is up to several tens of meters, and a floating cover 16 floating on the surface of crude oil to move upward and downward following the level of the crude oil. The body 11 has a catch portion 12 on the inner surface at a height of about 2 meters to limit the range in which a floating cover 16 moves downward. The floating cover 16 is caught by the catch portion 12, thereby being prevented from moving downward further. A manhole 13 is formed in the body 11 below the catch portion 12, allowing a worker to enter the body 11 therethrough. An outlet 14 is connected to an oil pipeline, allowing crude oil to be introduced into or discharged from the body 11 therethrough. The floating cover 16 has a manhole through which a worker can enter the body 11 and air vent holes 18 through which gases produced from crude oil are discharged to the outside.

As illustrated in FIG. 1, the water washing method for the crude oil tank 10 according to an embodiment of the invention includes: inert gas input step S10, washing preparation step S20, washing water input step S30, steam spraying step S40, high-pressure water injection step S50, mixture water discharge step S60, swirling water input step S70, mixture water refining step S100, and finishing step S90.

At the inert gas input step S10, an inert gas is input into the crude oil tank 10 before devices of the water washing system according to an embodiment of the invention are disposed in the crude oil tank 10 in order to prevent a fire or explosion.

The crude oil tank 10 is vulnerable to explosion caused by a spark that may occur in the washing preparation step since the crude oil tank 10 contains highly flammable gases produced from crude oil. For the sake of safety, the inert gas is input into the crude oil tank 10 to prevent such an accident.

At the washing preparation step S20, the devices of the water washing system according to the invention are disposed in the crude oil tank 10 for the purpose of a washing operation.

At the washing water input step S30, washing water is input into the crude oil tank 10. The amount of the washing water input ranges from 2 to 4 times the amount of sludge within the crude oil tank 10. For reference, although the terms, such as washing water, high-pressure water, mixture water, and swirling water, are expressed in a discriminative manner, these terms commonly refer to “water” used in the washing operation. These terms are distinguished based on their functions and actions in order to avoid confusion in the understanding of the invention.

At the steam spraying step S40, hot steam is sprayed onto the surface of the sludge 1 stuck to the bottom of the crude oil tank 10, substantially melting the sludge 1. That is, at least some components of the sludge are melted such that the sludge 1 is broken down into small pieces and detached from the bottom of the crude oil tank 10. This helps the sludge 1 mix with and be decomposed by the washing water. It is better for the steam to have a higher temperature and pressure. Herein, the process of “substantially melting” the sludge 1 refers to the process of melting at least some components of the sludge by spraying the hot steam to the sludge 1 such that the sludge 1 is broken down into small pieces and detached from the bottom of the crude oil tank 10, whereby the sludge 1 easily mixes with water.

At the high-pressure water injection step S50, high-pressure water is injected onto the bottom of the crude oil tank 10, i.e. the surface of the sludge 1, to decompose the sludge 1 that has been substantially melted by the steam and thus is readily decomposable, such that the decomposed sludge mixes with washing water.

In this case, it is preferable that the temperature of the high-pressure water is 50° C. or higher, such that the sludge 1 can be easily substantially melted, decomposed, and mixed.

At the mixture water discharge step S60, the sludge 1, which has been substantially melted and decomposed by the steam and the high-pressure water injected thereto and is mixed with the washing water, is discharged to the outside. In other words, the mixture water, i.e. a mixture of the washing water, the steam, the high-pressure water and the substantially molten and decomposed sludge 1, is discharge to the outside. The process of injecting high-pressure water continues while the mixture water is being discharged to the outside. For reference, the high-pressure water at this time may be not only the high-pressure water injected at the high-pressure water injection step, but also water supplied to maintain the water level. It is preferable that the discharged mixture water is from the upper layer of the mixture water in which the density of the sludge 1 is higher.

When the amount (height) of the sludge 1 accumulated on the bottom of the crude oil tank 10 is large (high), it is difficult to remove all the sludge 1 in one step by spraying steam and injecting high-pressure water. In this case, after the process of discharging the mixture water is stopped, the steam spraying step S40, the high-pressure water injection step S50, and the mixture water discharging step S60 are repeated such that all the sludge 1 is separated and detached from the bottom of the crude oil tank 10.

When the concentration of the sludge 1 in the mixture water becomes less than a reference value as the mixture water is continuously discharged to the outside, at the swirling water input step S70, the process of injecting the high-pressure water intended to maintain the water level in response to the mixture water being discharged is stopped, and swirling water is input to the bottom of the crude oil tank 10 from the center within the crude oil tank 10, such that the majority of the mixture water centrifugally gathers near the inner wall of the crude oil tank 10.

That is, the swirling water is injected such that it swirls at the center on the bottom of the crude oil tank 10 while pushing the mixture water outward, such that the mixture water centrifugally gathers near the inner wall of the crude oil tank 10. Consequently, the mixture water containing the sludge 1 is discharged to the outside. In other words, the fresh swirling water without impurities is supplied to the center of the crude oil tank 10, driving the sludge 1 outward within the crude oil tank 10, and the mixture water containing the sludge 1 is continuously discharged to the outside, such that all the sludge 1 is consequently discharged from the crude oil tank 10.

At the mixture water refining step S100, the mixture water discharged at the mixture water discharging step S60 and the subsequent steps is refined and divided into waste oil, dirty water, and solid wastes to be incinerated. The waste oil divided through the refining is recycled as oil, the dirty water divided through the refining is recycled into the crude oil tank 10 that is being currently washed or will be washed next, and the solid wastes from which the oil and water components are substantially removed are incinerated.

When the concentration of the sludge 1 in the mixture water discharged through the swirling water input step S70 becomes a reference value, at S80, the process of inputting the swirling water is stopped, and all the remaining mixture water is discharged. Thereafter, at the finishing step S90, workers enter the crude oil tank 10, clean the residue that has not been removed, and discharge the remaining mixture water that has not been discharged, thereby finishing the washing operation.

At the finishing step S90, the interior of the crude oil tank 10 has been washed with water in the previous processes, such that substantially no oil components remain. The concentration of the oil components is at a level that does not require the workers to wear masks when entering the crude oil tank 10.

The water washing system for a crude oil tank according to the invention will now be described in greater detail with reference to FIG. 8 from FIG. 2. In addition, the water washing method will be more clearly understood from the following description of the water washing system.

The water washing system according to an embodiment of the invention includes a water tank 20, a water supply pump 30, a boiler 40, an air compressor 50, a high-pressure pump 60, a drain pump 70, a rotary unit 80, a refiner 90, a recycling pump 100, and the like. These components are connected to the crude oil tank 10 via hoses, pipes, and the like.

Devices (components) of the water washing system will now be described according to the sequence of the washing operation.

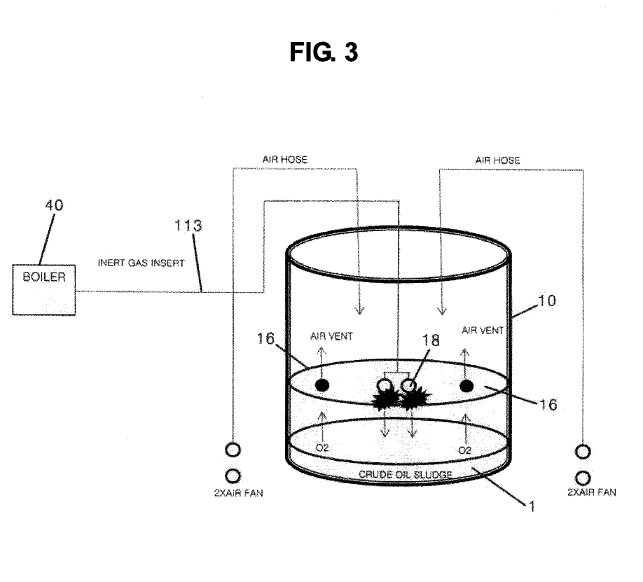

FIG. 3 is a diagram illustrating an operation of inputting inert gas into a crude oil tank.

The water washing system includes a gas injecting means for injecting inert gas into the crude oil tank 10 in order to discharge flammable gases from the crude oil tank 10. Inert gas may be nitrogen gas, air hose and fan may be used in order to discharge flammable gases, and density of Oxigen of oil tank 10 inside must be below 5% simutaneoulsy.

The gas injecting means includes a storage barrel 111 containing a liquid (or solid) inert material, a hose 113 through which an inert gas gasified from the inert material through a boiler 40 is supplied to the crude oil tank 10, and a compressor 115 or a blower fan providing a driving force with which the inert gas can flow through a passage.

The hose 113 extends into the crude oil tank 10 through one of the air vent holes 18 of the floating cover 16, and consequently, the inert gas within the crude oil tank 10 is discharged to the outside through another one of the air vent holes 18.

When the safety of the crude oil tank 10 is guaranteed by the input of the inert gas, steam pipes, hose, distributors, valves, the rotary unit, and the like are mounted on the body 11 and the floating cover 16, whereby the main processes of washing the crude oil tank 10 are ready.

The water tank 20 contains water to be supplied to the crude oil tank 10 (water to be used as washing water, high-pressure water, swirling water, steam, and the like).

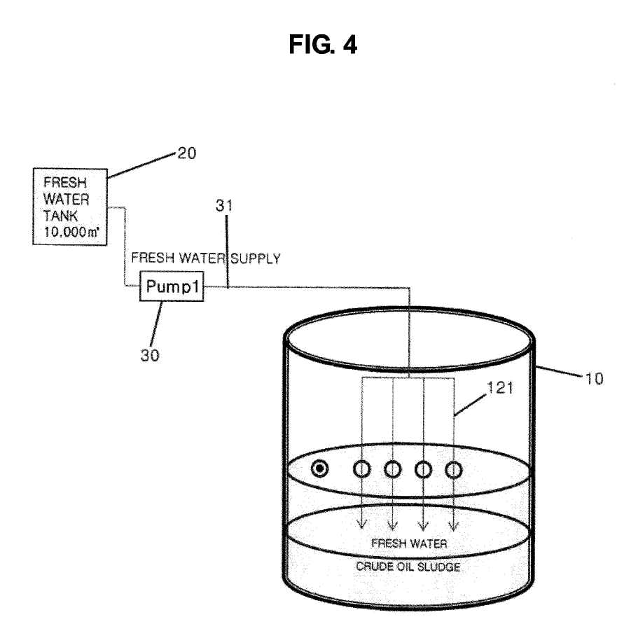

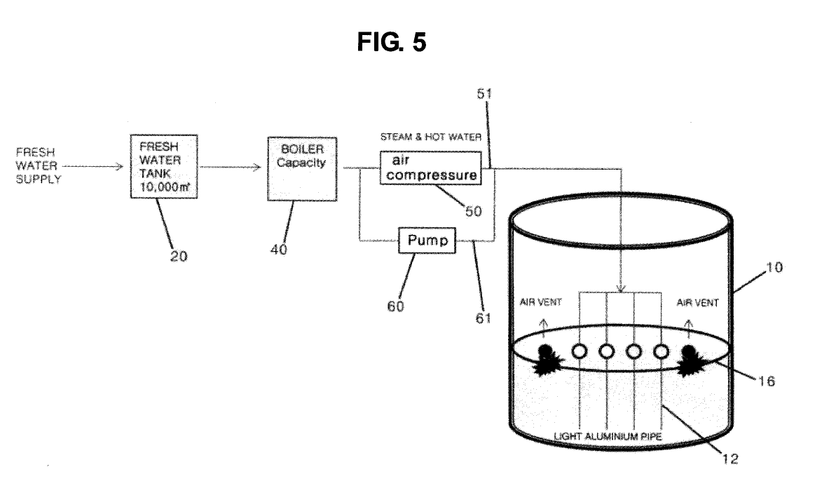

FIG. 4 is a diagram illustrating an operation of inputting washing water into the crude oil tank; FIG. 5 is a diagram illustrating an operation of spraying steam and injecting high-pressure water into the crude oil tank.

The water supply pump 30 inputs the water contained in the water tank 20 to the crude oil tank 10. That is, the water contained in the water tank 20 is input to the crude oil tank 10 as washing water. The water tank 20, the water supply pump 30, and the crude oil tank 10 are connected to each other via hoses that form passages. The water in the water tank 20 can be heated to hot washing water (e.g. 50° C. or higher) through the boiler 40 before being input to the crude oil tank 10.

A hose 31 forming a passage for the washing water is preferably implemented as a fire hose that is flexible while being durable. The fire hose may extend through the opened manhole 17 in the floating cover 16, directly inputting the washing water into the crude oil tank 10. Alternatively, the fire hose may be connected to a distributor disposed on the floating cover 16, inputting the washing water into the crude oil tank 10 through a steam pipe 121.

The boiler 40 produces hot steam by heating water introduced from the water tank 20. The boiler 40 can also produce hot washing water and hot high-pressure water by heating water introduced from the water tank 20 in addition to the steam.

The steam produced in the boiler 40 can be directly input into the crude oil tank through a hose, or can be sprayed at a higher pressure through the air compressor 50 before being inputted into the crude oil tank through a hose. The steam produced directly from the boiler or through the air compressor 50 enters a distributor 120 disposed on the floating cover 16 through a hose 51.

The distributor 120 distributes the introduced steam to a plurality of steam pipes 121. The steam pipes 121 extend into the crude oil tank 10 through the air vent holes 18 of the floating cover 16, with the upper portions of the steam pipes 121 being connected to the distributor 120, and the lower portions are disposed at the bottom of the crude oil tank 10 to spray the steam onto the sludge 1.

The position of the floating cover 16 is not fixed, and the thickness of the sludge 1 gradually decreases as the sludge is substantially melted. It is therefore preferable that the length of each of the steam pipes 121 is freely adjustable such that the hot high-temperature steam can be continuously sprayed to the lower portion of the crude oil tank 10, i.e. the surface of the sludge 1.

Free adjustment in the length of each steam pipe 121 may be enabled by a stepless structure, i.e. a structure including several pipes having different diameters in which each inner pipe is fitted into a corresponding outer pipe, the inner diameter of which corresponds to the outer diameter of the inner pipe, such that the inner pipe can be withdrawn from and retracted into the outer pipe.

The steam pipe 121 having the stepless structure is disposed along the vertical direction. When the distance between the floating cover 16 and the surface of the sludge 1 increases, a corresponding pipe is gradually withdrawn such that the lower end thereof keeps in contact with the surface of the sludge 1. When the distance between the floating cover 16 and the surface of the sludge 1 decreases, a corresponding pipe is gradually retracted by a pressing force applied to the lower end in contact with the surface of the sludge 1.

he high-pressure pump 60 injects water from the water tank 20 under a high pressure onto the bottom of the crude oil tank 10. In this case, it is preferable that the high-pressure water is prepared by heating the water from the water tank 20 to a high temperature (e.g. 50° C. or higher) through the boiler 40. This is more advantageous to decompose the sludge 1 and help the sludge 1 mix with the washing water than using the water from the water tank 20 as it is.

The high-pressure pump 60 supplies the high-pressure water to the distributor 120 through the hose 61, and the distributor 120 injects the high-pressure water onto the bottom of the crude oil tank 10 through the steam pipes 121.

Although the high-pressure pump 60 may be prepared separately, the water supply pump 30 may act as the high-pressure pump 60, and the hose that forms a passage for the high-pressure water pumped using the high-pressure pump 60 may be implemented as the hose 31 that forms a passage for the washing water pumped using the water supply pump 30.

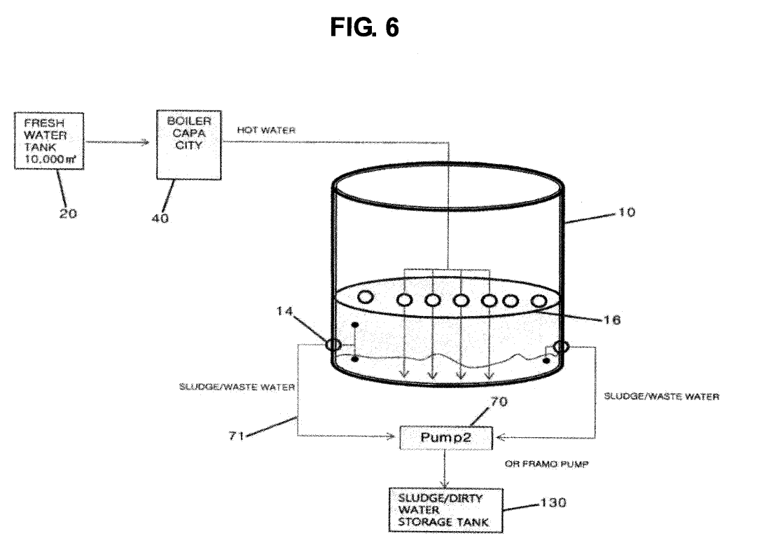

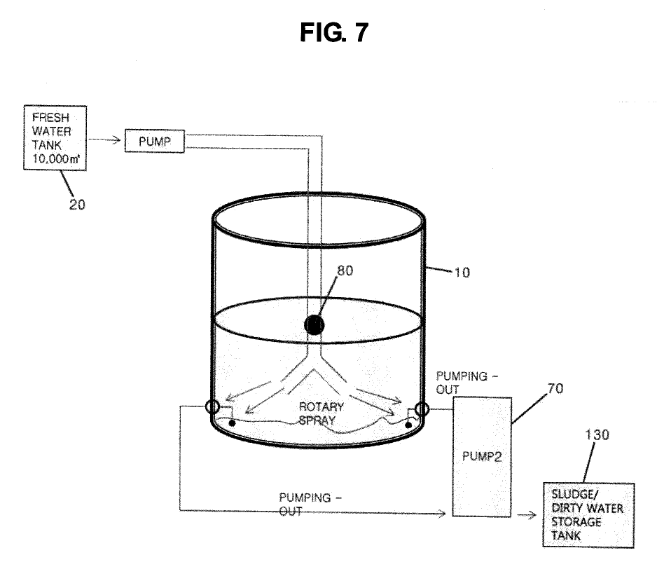

FIG. 6 is a diagram illustrating an operation of discharging mixture water from the crude oil tank; FIG. 7 is a diagram illustrating an operation of inputting swirling water into the crude oil tank.

The drain pump 70 discharges the mixture water, in which the sludge 1 is broken down, detached and decomposed due to the injection of the washing water, the steam, and the high-pressure water, from the crude oil tank 10.

A hose 71 that forms a passage for the drain pump 70 is connected to the outlet 14 provided in the lower side of the body 11 of the crude oil tank 10. Since the specific weight of the sludge 1 is lower than the specific weight of water, a majority of the sludge 1 is present in the upper layer of the mixture water. It is therefore preferable that the hose for the drain pump 70 extends through the outlet 14 such that the entrance thereof is in the upper layer of the mixture water.

The rotary unit 80 inputted into the body 11 through the manhole in the floating cover 16 is disposed in the upper central portion above the bottom of the body 11.

The rotary unit 80 is configured to inject a large amount of swirling water under a strong pressure onto the bottom while rotating. After all the sludge 1 stuck to the bottom of the crude oil tank 10 is detached therefrom and most of the sludge 1 is discharged in the mixture water, the high-pressure pump 60 is stopped, whereby the injecting of the high-pressure water is stopped. The mixture water within the crude oil tank 10 decreases, and the floating cover 16 is caught by the catch portion 12 of the body 11. In the state in which the level of the mixture water becomes equal to or lower than a predetermined reference level, the rotary unit 80 starts operating.

The rotary unit 80 includes a rotatable rotary shaft disposed in the vertical direction, an injection port coupled with the rotary shaft and horizontally disposed in a downward direction with respect to the rotary shaft, and a pump for supplying a large amount of high-pressure swirling water.

The rotary shaft rotates under the pressure of the swirling water injected through the injection port, injecting the swirling water in the direction from the center to the circumference on the bottom of the crude oil tank 10. The pump supplies the large amount of high-pressure swirling water to the distributor 120, which in turn injects the swirling water onto the injection port through the hose.

When almost no sludge 1 remains in the mixture water (mostly swirling water) as the swirling water containing the sludge 1 gathers near the inner wall of the crude oil tank 10 and then is discharged by the drain pump 70, the injection of the swirling water is stopped, and the drain pump 70 discharges the mixture water remaining in the crude oil tank 10 to the outside. In this manner, the majority of the operation of washing the crude oil tank 10 is carried out. Afterwards, workers open the manhole disposed in the body 11 of the crude oil tank 10 and enter the crude oil tank 10 to finish the washing operation. Accordingly, a series of the water washing operation for the crude oil tank 10 is completed.

FIG. 8 is a diagram illustrating an operation of refining the mixture water discharged and collected.

The refiner 90 is configured to divide the mixture water discharged through the drain pump 70 into waste oil, dirty water, and solid wastes to be incinerated by refining the mixture water. The mixture water discharged through the drain pump 70 is temporarily stored in a collector tank(130). The mixture water is then supplied from the collector tank (130) to the refiner 90, which in turn divides the mixture water into components by refining.

The refiner 90 refines the sludge 1 using centrifugal force. Specifically, the refiner 90 rotating the introduced mixture water at a high speed such that the mixture water is divided into waste oil, dirty water, and solid wastes to be incinerated based on different densities thereof, and subsequently discharges the divided components.

The divided waste oil is recycled and used as an energy source. The divided dirty water is supplied to the water tank 20 through a recycling pump 100 to be reused in the washing operation for the crude oil tank 10 or another crude oil tank 10. The divided solid wastes are incinerated.

Although the exemplary embodiments of the water washing method and system for a crude oil tank according to the present invention have been described for illustrative purposes, a person skilled in the art will appreciate that various modifications, additions and substitutions are possible, without departing from the scope and spirit of the present invention as disclosed in the accompanying claims.

1. A water washing method for a crude oil tank comprising:
inputting washing water into the crude oil tank;
injecting high-pressure water to the lower portions of the crude oil tank such that the sludge mixes with the washing water; and
discharging mixture water in which the sludge is mixed with the washing water from the crude oil tank.

2. The water washing method according to claim 1, further comprising, when a concentration of the sludge in the discharged mixture water is smaller than a predetermined value, inputting swirling water to the lower portions of the crude oil tank from a central upper portion of the crude oil tank such that the mixture water centrifugally gathers near an inner wall of the crude oil tank.

3. The water washing method according to claim 1, further comprising:
spraying hot steam to the lower portions of the crude oil tank such that the sludge is substantially melted.

4. The water washing method according to claim 1, further comprising refining the mixture water to divide the mixture water into waste oil, dirty water, and solid wastes to be incinerated.

5. The water washing method according to claim 1, wherein a dirty water divided from the mixture water through refining is to be reused in water washing for the crude oil tank.

6. A water washing system for a crude oil tank comprising:
a water supply pump inputting washing water into the crude oil tank;
a high-pressure pump injecting high-pressure water to the lower portions of the crude oil tank; and
a drain pump discharging mixture water in which sludge is mixed with the washing water from the crude oil tank.

7. The water washing system according to claim 6, further comprising a rotary unit inputting swirling water to the lower portions of the crude oil tank from a central upper portion of the crude oil tank such that the mixture water gathers near an inner wall of the crude oil tank.

8. The water washing system according to claim 6, further comprising a boiler producing hot steam to be sprayed to the lower of the crude oil tank.

9. The water washing system according to claim 6, further comprising a refiner refining the mixture water discharged through the drain pump to divide the mixture water into waste oil, dirty water and solid wastes to be incinerated.

10. The water washing system according to claim 6, further comprising a recycling pump supplying the dirty water refined and divided from the mixture water by the refiner to a water tank.
